(19) United States
(12) Patent Application Publication
(10) Pub. No.: US 2006/0200465 A1
(43) Pub. Date: Sep. 7, 2006

(54) METHOD FOR SEARCHING A COMPUTER FILE IN A FILE DIRECTORY ACCORDING TO ITS FILE NAME

(76) Inventor: Tsung-Hua Chuang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/164,779

(22) Filed: Dec. 6, 2005

(30) Foreign Application Priority Data
Dec. 17, 2004 (TW) 093139365

(51) Int. Cl. G06F 17/30

(52) U.S. Cl. 707/6

(57) ABSTRACT

The present invention provides a method for searching a file in a file directory according to a given file name of the file. The method includes the steps of: counting number k of characters of the file name; calculating number n of files in the file directory; executing a first searching method when (2k)*>=n, including the steps of: comparing the given file name with each file name in the file directory; and opening the file if any file name matches the given file name; executing a second searching method when (2k)*<n, including the steps of: enumerating all potential file names of case-sensitive characters according to the given file name; and trying to open file with each of the potential file names. The above-mentioned p means the ratio of time consumed by opening a file with a file name over time consumed by comparing the given file name with another file name.

### FIELD OF THE INVENTION

The present invention is generally related to methods for searching a computer file in a file directory, and, more particularly, is related to a method for searching a computer file in a file directory of a case-sensitive file system.

### DESCRIPTION OF RELATED ART

As NetBIOS appears, Microsoft proposes a new network protocol named Server Message Block (SMB) for sharing files between computers connected by a network. The SMB protocol is based on NetBIOS. In the beginning, Microsoft applies the SMB protocol mainly in Windows NT server system. Later on, as Windows client systems become popular, the SMB protocol is also used in Windows client systems.

As the Internet prevails and is broadly used in common life, sharing resources happens frequently between computers connected by the Internet. Accordingly, Microsoft improves the SMB protocol and later launches a new edition named Common Internet File System (CIFS). The CIFS now becomes a standard Internet protocol.

However, most of the servers in Internet are installed with Unix or Linux operating system. In order to share resources between Unix server and Windows client computer, a software that supports SMB/CIFS should be installed in the Unix server. Such a software may be Samba, by which users can share resources between Unix server and Windows client computer through SMB/CIFS.

A Windows client computer typically runs a case-insensitive file system to manage files such as FAT16, FAT32, and NTFS, while a Unix server typically runs a case-sensitive file system such as EXT2, EXT3, and REISER. For example, aBcde.txt and Abcde.txt are viewed as one file in a case-insensitive file system, while two different files in a case-sensitive file system. If the Windows client computer requests for searching a file with a given file name in the Unix server, the Unix server typically needs to read all files from the file system and compare each file name with the given file name to determine whether the file exists in the Unix server.

It would take much time to search a file in a Unix server if a large amount of files are stored in the case-sensitive file system of the Unix server. In fact, a Unix server usually stores files as many as hundreds of millions, or even hundreds of billions.

Accordingly, what is needed is a solution that can search a file in a case-sensitive file system more efficiently in time consuming.

### SUMMARY OF INVENTION

Embodiments of the present invention provide methods for searching a file in a case-sensitive file system more efficiently in time consuming.

Briefly described, one embodiment of such a method among others, can be implemented as described herein. The method searches a file according to the given file name of the file. The file is stored in a file directory of a file system, such as a case-sensitive file system. The method includes the steps of: counting total number k of characters of the given file name; calculating total number n of files currently stored in the file directory; comparing (2k)*p with n. There are two sub-methods called a first searching method and a second searching method to be selected for subsequent search after the total number k of characters of the given file name and the total number n of the files currently stored in the file directory have been calculated. The first searching method is selected when (2k)*>=n. The first searching method includes the steps of: comparing the given file name with each file name of the files currently stored in the file directory; and opening the file if any file name matches the given file name. The second searching method is selected when (2k)*<n. The second searching method includes the steps of: enumerating all potential file names of case-sensitive characters according to the given file name; and trying to open a file with each of the potential file names. The above-mentioned p means the ratio of time period consumed by trying to open a file with a file name in executing the second searching method over time period consumed by comparing the given file name with another file name in executing the first searching method.

Other systems, methods, features, and advantages of the present invention will be or become apparent to one with skill in the art upon examination of the following drawings and detailed description.

### BRIEF DESCRIPTION OF DRAWINGS

FIG. 1 is a schematic diagram that illustrates a hardware environment which implements a method for searching a file in a file directory, in accordance with one embodiment of the present invention;

FIG. 2 is a flowchart that illustrates a first searching method for searching a file in a file directory, in accordance with one embodiment of the present invention;

FIG. 3 is a flowchart that illustrates a second searching method for searching a file in a file directory, in accordance with one embodiment of the present invention; and

FIG. 4 is a flowchart that illustrates a method which intelligently chooses a faster one between the first searching method and the second searching method to search a file in a file directory, in accordance with one embodiment of the present invention.

### DETAILED DESCRIPTION

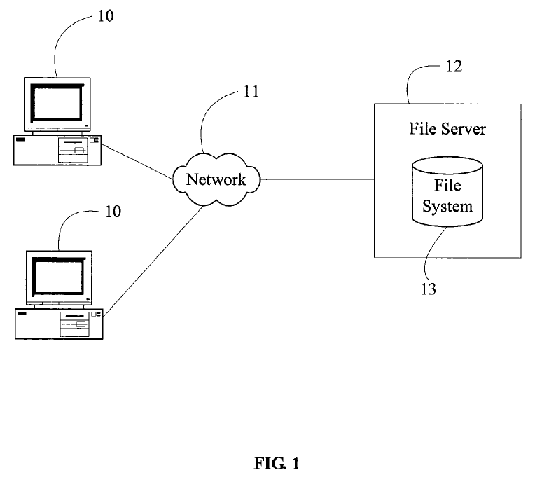

FIG. 1 is a schematic diagram that illustrates a hardware environment which implements a method for searching a file in a file directory, in accordance with one embodiment of the present invention. In the hardware environment, a plurality of client computers 10 are connected to a file server 12 via a network 11. The file server 12 has a file system 13 installed therein which manages a large amount of files.

The client computer 10 may be a personal computer (PC), which may have a plurality of hardware devices therein, such as a central processing unit (CPU), a memory, a hard-disk, a monitor, a mouse and a key board. The client computer 10 may also be installed with some software, such as an operating system (OS) and application software. Typically, the client computer 10 is installed with a Windows OS, the file system of which is typically case-insensitive, such as FAT16, FAT32, and NTFS.

The file server 12 may be a PC, like the client computer 10, or a network server computer, which typically has larger throughput and faster processing speed than a PC. The file server 12 typically has a Unix-based operating system installed therein such as a Unix OS or a Linux OS, and runs the file system 13. The file system 13 is typically case-sensitive, such as EXT2, EXT3, and REISER. In order to provide file-sharing service to the client computer 10, the file server 12 further has a Samba software installed therein, which supports Server Message Block (SMB) and Common Internet File System (CIFS).

The network 11 can be an electronic network based on a Transfer Control Protocol and Internet Protocol (TCP/IP), such as a Local Area Network (LAN), Intranet or the Internet. Via the network 11, the client computer 10 can request for file-sharing service from the file server 12, such as searching a file in a file directory in the file system 13.

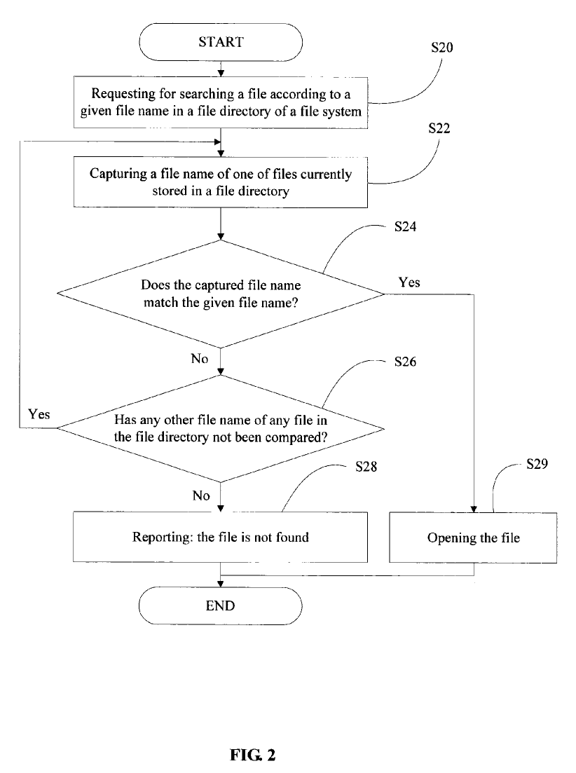

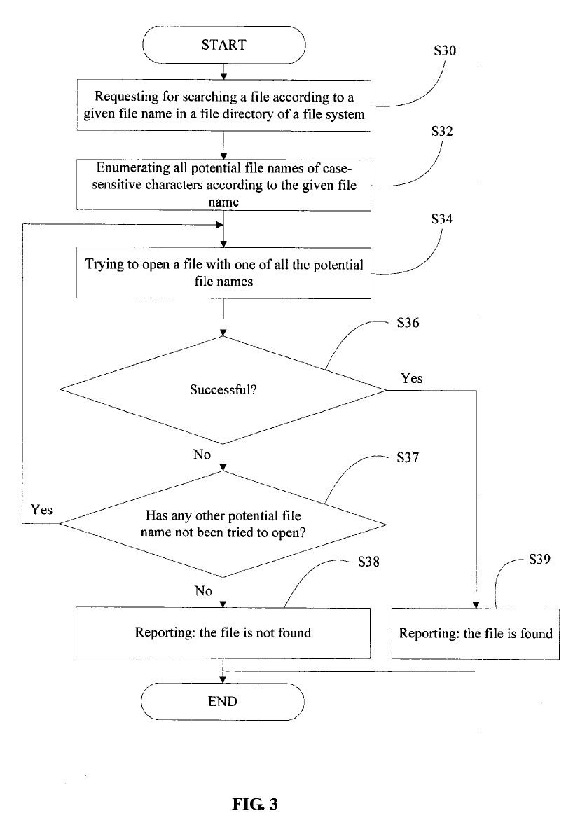

Two searching methods for searching a file in a file directory will be described below respectively in relation to FIG. 2 and FIG. 3. Suppose that the client computer 10 requests for searching a file in a certain file directory in the file system 13. The file is given a file name of Ab.txt.

FIG. 2 is a flowchart that illustrates a first searching method for searching the file Ab.txt in the file directory, in accordance with one embodiment of the present invention. Having received the request for searching the file Ab.txt from the client computer 10, the file server 12 compares the given file name Ab.txt with each file name of files currently stored in the file directory. If a file name of any file matches Ab.txt, the file server 12 opens the file, and reports to the client computer 10 that the file Ab.txt is searched. Otherwise, the file server 12 reports to the client computer 10 that the file Ab.txt is not searched. The first searching method is described below in detail for readily understanding.

In step S20, the client computer 10 requests for searching the file according to its file name Ab.txt in the file directory. In step S22, the file server 12 receives the request and then captures a file name of one of the files currently stored in the file directory. In step 24, the file server 12 compares the captured file name with the given file name Ab.txt so as to determine whether the captured file name matches the given file name Ab.txt. If the captured file name matches Ab.txt exactly, in step S29, the file server 12 opens the corresponding file of Ab.txt and reports to the client computer 10 that the file Ab.txt is found. The procedure of the first searching method ends.

On the contrary, if in step S24 the captured file name does not match Ab.txt, in step S26, the file server 12 determines whether any other file name in the directory has not been compared with the given file name Ab.txt. If all file names of the files in the directory have been compared, in step S28, the file server 12 reports to the client computer 10 that the file Ab.txt is not found and the procedure of the first searching method ends. Otherwise, if any other file name of any file in the directory has not been compared, the procedure returns to step S22 described above.

FIG. 3 is a flowchart that illustrates a second searching method for searching the file Ab.txt in the file directory, in accordance with one embodiment of the present invention. Having received the request for searching the file Ab.txt from the client computer 10, the file server 12 enumerates all potential file names of case-sensitive characters according to the given file name Ab.txt. The potential file names of Ab.txt include Ab.txt, AB.txt, ab.txt and aB.txt. The file server 12 tries to open a file with each of the above-mentioned potential file names. If succeeding to open a file with one of the above-mentioned potential file names, the file server 12 reports to the client computer 10 that the file Ab.txt is found. Otherwise, the file server 12 reports to the client computer 10 that the file Ab.txt is not found. The second searching method is described below in detail for readily understanding.

In step S30, the client computer 10 requests for searching the file according to its file name Ab.txt in the file directory. In step S32, the file server 12 receives the request and then enumerates all potential file names of case-sensitive characters according to the given file name Ab.txt. The potential file names of Ab.txt include Ab.txt, AB.txt, ab.txt and aB.txt. In step S34, the file server 12 tries to open a file with one of the above-mentioned potential file names. In step S36, the file server 12 checks whether the file with the potential file name is successfully opened. If succeeding in opening the file with the potential file name, in step S39, the file server 12 reports to the client computer 10 that the file Ab.txt is found. After the file search has been reported either found or not found, the procedure of the second searching method ends.

On the contrary, if in step S36 failing to open the file with the potential file name, in step S37, the file server 12 determines whether any other potential file name has not been tried and used to open the file. If all of the potential file names have been tried and used to open the file, in step S38, the file server 12 reports to the client computer 10 that the file Ab.txt is not found and the procedure of the second searching method ends here. Otherwise, if any other potential file name has not been tried to open, the procedure returns to step S34 described above.

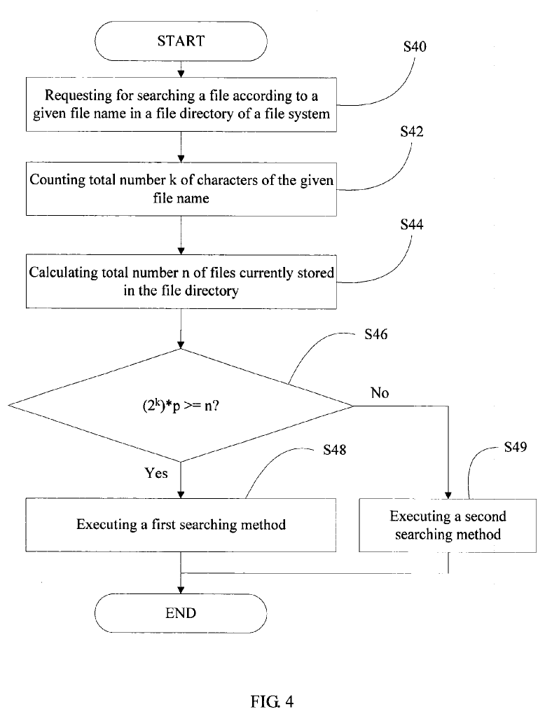

FIG. 4 is a flowchart that illustrates a method which intelligently chooses a faster one between the first searching method and the second searching method to search the file Ab.txt, in accordance with one embodiment of the present invention.

It should be noted that both the first searching method and the second searching method have been performed by the file server 12 for many times for a purpose of experiment before the method of FIG. 4 is performed. As a result of the experiment, p means the ratio of time period consumed by trying to open a file with a file name in executing the second searching method over time period consumed by comparing the given file name with another file name in executing the first searching method, and x means average number of files included in per size unit of the file system 13.

In step S40, the client computer 10 requests for searching the file according to its given file name Ab.txt in the file directory. In step S42, the file server 12 receives the request and counts total number k of characters of the given file name Ab.txt. In step S44, the file server 12 calculates total number n of the files currently stored in the file directory. The total number n is calculated by a formula n=n1+n2, in which n1 means the total number of files calculated in previously executing the first searching method, and n2=(s2−s1)*x. s2 means total size of all the files currently stored in the file directory, s1 means total size of all files when previously executing the first searching method, and x means the average number of files included in per size unit as set forth above. x is a constant which is evaluated by experiments in the file system 13. If the first searching method has not been executed yet, n is simply calculated by a formula n=s2*x.

In step S46, the file server 12 compares (2k)*p with n so as to determine whether (2k)*>=n, in which k is the total number of characters of the given file name, p is a constant which is evaluated by experiments in the file system 13 as set forth above. If (2k)*>=n, in step S48, the file server 12 executes the first searching method as described above in detail in relation to FIG. 2. Otherwise, if (2k)*<n, in step S49, the file server 12 executes the second searching method as described above in detail in relation to FIG. 3.

In an alternative embodiment, the file server 12 executes the first searching method when (2k)*>n, and executes the second searching method when (2k)*<=n.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1] A method for searching a file according to a given file name of the file, the file being stored in a file directory of a file system, the method comprising the steps of:
counting total number k of characters of the given file name;
calculating total number n of files currently stored in the file directory;
comparing (2k)*p with n;
executing a first searching method when (2k)*>=n, the first searching method comprising the steps of:
comparing the given file name with each file name of the files currently stored in the file directory; and
opening the file if any file name matches;
executing a second searching method when (2k)*<n, the second searching method comprising the steps of:
enumerating all potential file names of case-sensitive characters according to the given file name; and
trying to open a file with each of the potential file names;
wherein p means the ratio of time period consumed by trying to open a file with a file name in executing the second searching method over time period consumed by comparing the file name with another file name in executing the first searching method.

2] The method according to claim 1, wherein the file system is case-sensitive.

3] The method according to claim 1, wherein the total number n of files is calculated by a formula n=n1+n2, wherein:
n1 means the total number of files calculated in previously executing the first searching method; and
n2=(s2−s1)*x, wherein s2 means total size of all the files currently stored in the file directory, s1 means total size of all files when previously executing the first searching method, and x means average number of files included in per size unit.

4] The method according to claim 3, wherein n is calculated by a formula n=s2*x if the first searching method has not been executed yet.

5] A method for searching a file according to a given file name of the file, the file being stored in a file directory of a file system, the method comprising the steps of:
counting total number k of characters of the given file name;
calculating total number n of files currently stored in the file directory;
comparing (2k)*p with n;
executing a first searching method when (2k)*>n, the first searching method comprising the steps of:
comparing the given file name with each file name of the files currently stored in the file directory; and
opening the file if any file name matches;
executing a second searching method when (2k)*<=n, the second searching method comprising the steps of:
enumerating all potential file names of case-sensitive characters according to the given file name; and
trying to open a file with each of the potential file names;
wherein p means the ratio of time period consumed by trying to open a file with a file name in executing the second searching method over time period consumed by comparing the file name with another file name in executing the first searching method.

6] The method according to claim 5, wherein the file system is case-sensitive.

7] The method according to claim 5, wherein the total number n of files is calculated by a formula n=n1+n2, wherein:
n1 means the total number of files calculated in previously executing the first searching method; and
n2=(s2−s1)*x, wherein s2 means total size of all the files currently stored in the file directory, s1 means total size of all files when previously executing the first searching method, and x means average number of files included in per size unit.

8] The method according to claim 7, wherein n is calculated by a formula n=s2*x if the first searching method has not been executed yet.
